(19) United States
(12) Patent Application Publication
(10) Pub. No.: US 2024/0356948 A1
(43) Pub. Date: Oct. 24, 2024

(54) SYSTEM AND METHOD FOR UTILIZING MULTIPLE MACHINE LEARNING MODELS FOR HIGH THROUGHPUT FRAUD ELECTRONIC MESSAGE DETECTION

(71) Applicant: Barracuda Networks, Inc., Campbell, CA (US)

(72) Inventors: Seyed Armin Seyeditabari, San Francisco, CA (US); Christopher L. Sawtelle, Santa Clara, CA (US)

(21) Appl. No.: 18/425,909

(22) Filed: Jan. 29, 2024

Related U.S. Application Data
(60) Provisional application No. 63/461,205, filed on Apr. 21, 2023.
(60) Provisional application No. 63/545,594, filed on Oct. 25, 2023.

(51) Int. Cl. H04L 9/40

(52) U.S. Cl. CPC H04L 63/1425; H04L 63/1416

(57) ABSTRACT

A new approach is proposed to support utilizing multiple machine learning (ML) models for electronic message filtering and fraudulent detection. The proposed approach uses a combination of one or more small ML models having a small number of parameters with fast inference time and one or more large ML models having a large number of parameters with higher discriminatory powers to identify fraudulent electronic messages with precision. The proposed approach leverages the combination of both the small and large ML models to efficiently and accurately sort through electronic messages received, and to identify/detect fraudulent electronic messages with a high level of precision. Specifically, the proposed approach first utilizes the small ML models with fast inference time to provide the initial sorting, and then utilizes the large ML models with higher discriminatory powers to carry out more in-depth analysis to identify fraudulent electronic messages with greater accuracy.

### CROSS-REFERENCE TO RELATED APPLICATIONS

This application claims the benefit of U.S. Provisional Patent Application No. 63/461,205, filed Apr. 21, 2023, which is incorporated herein in its entirety by reference.

This application further claims the benefit of U.S. Provisional Patent Application No. 63/545,594, filed Oct. 25, 2023, which is incorporated herein in its entirety by reference.

### BACKGROUND

In today's digital age, organizations are facing a multitude of cyber-attacks launched via electronic messages (e.g., emails) in various forms and formats. To avoid significant financial losses resulting from these email-based cyber-attacks, most email security systems currently use rule-based or conventional machine learning (ML) approaches to detect and mitigate such cyber-attacks. However, the emergence of large ML (or deep learning) models, such as large language models (LLMs) and multimodal models, has provided a valuable tool to assist the organizations in filtering out and identifying fraudulent emails before the fraudulent emails even reach their intended recipients. These large ML models are usually trained on vast amounts of text to understand existing content of the electronic messages. In the case of image intent analysis for fraud (e.g., phishing) email detection, large ML models (e.g., multimodal models) have shown tremendous promise in augmenting traditional statistical models by providing additional features that have been out of reach for these models due to constraints in traditional feature extraction methods. Those methods often relied on OCR and other edge detection methods to pull the intent out of an image but can be circumvented if the image is used without text.

The use of large ML models for email classification, however, is hindered by the long time it takes to infer the content of the emails. Specifically, large ML models, such as LLMs and multimodal models, typically have millions to billions of parameters, and are not practical for high throughput applications such as real time email classification. This is because these large ML models require a huge amount of processing power and graphic processing unit (GPU) acceleration, resulting in significantly longer inference times and higher operational expenses than small ML models. In contrast, the small ML models such as Random Forest and Extreme Gradient Boosting or XGBoost, have fewer number (i.e., thousands or hundreds of thousands) of parameters, require less processing power, and can be deployed on general purposed CPU-accelerated units/endpoints. Consequently, these small ML models have lower inference times and are more cost-effective to deploy and maintain. However, these small ML models are not always accurate in terms of content classification due to their relatively smaller number of parameters.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support utilizing multiple machine learning models for fraudulent electronic message detection in accordance with some embodiments.

FIG. 2 depicts an example of a process of classifying intent of an image in a phishing email through one or more LLMs and/or multimodal models in accordance with some embodiments.

FIG. 3 depicts a flowchart of an example of a process to support utilizing multiple machine learning models for fraudulent electronic message detection in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Fraudulent detection and identification are crucial aspects of electronic message filtering. Performance of a fraudulent electronic message (e.g., email) detection system depends on two critical factors. The first factor is the accuracy of the fraudulent email detection system in detecting a plurality of fraudulent emails with the lowest possible number of false positives and false negatives. False positives occur when legitimate emails are mistakenly identified as fraudulent, and false negatives occur when fraudulent emails pass undetected. A high level of accuracy in detecting fraudulent emails is essential to ensure that legitimate emails are not erroneously filtered out while fraudulent emails are caught and prevented from causing harm. The second factor is the time it takes for the fraudulent email detection system to make its determination. It is vital to minimize the time taken for the system to identify fraudulent emails and sort them out in order to ensure that users can access their emails as soon as possible. As such, the fraudulent email detection system must be designed to be able to handle large volumes of emails with accuracy, as it may encounter tens of thousands of emails per second during peak usage.

A new approach is proposed that contemplates systems and methods to support utilizing multiple machine learning (ML) models for electronic message filtering and fraudulent detection. The proposed approach uses a combination of one or more small ML models having a small number (e.g., tens of thousands) of parameters with fast inference time and one or more large ML models having a large number (e.g., tens of millions) of parameters with higher discriminatory powers to identify fraudulent electronic messages with precision. The proposed approach then leverages the combination of both the small and large ML models to efficiently and accurately sort through one or more electronic messages received, and to identify/detect a set of fraudulent electronic messages with a high level of precision. Specifically, the proposed approach first utilizes the small ML models with fast inference time to provide the initial sorting, and then utilizes the large ML models with higher discriminatory powers to carry out more in-depth analysis to identify fraudulent electronic messages with greater accuracy. As a result, the proposed approach delivers fast and reliable electronic messages filtering while minimizing the risk of false positives and false negatives.

By combining the fast inference time of the smaller ML models with the superior identification capabilities of the larger ML models, the proposed approach creates and utilizes a set of ML models capable of processing a large number of electronic messages per second while benefiting from the enhanced performance of the larger ML models. Despite utilizing large models for inference only as needed, the proposed approach minimizes reliance on large ML models and reduces the cost (e.g., money, time, processing power) of inference significantly compared to large ML model only approaches. As such, the proposed approach represents an optimal solution that combines the best of the two types of ML models with large and small parameter numbers, respectively, thus significantly enhancing security and reducing the risk of financial loss due to scams and cyber-attacks to organizations via electronic messages.

As discussed hereinafter, electronic messages include but are not limited to emails, text messages, instant messages, online chats on a social media platform, voice messages or mails that are automatically converted to be in an electronic text format, or other forms of text-based electronic communications. Although email is used as a non-limiting example of the electronic message in the discussions below, same or similar approach can also be applied to other types of text-based electronic messages listed above.

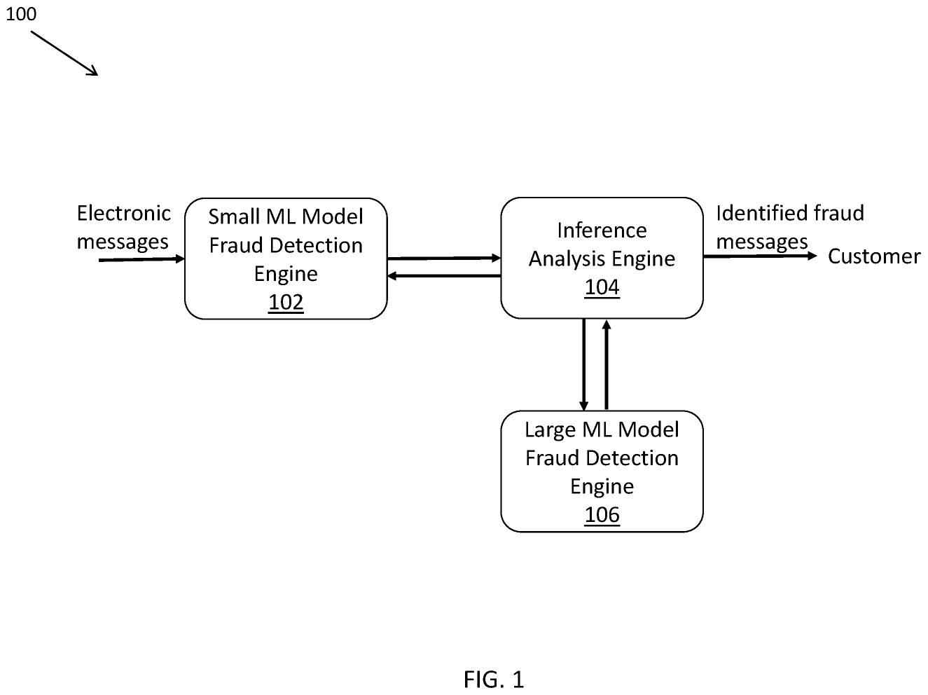

FIG. 1 depicts an example of a system diagram 100 to support utilizing multiple machine learning models for fraudulent electronic message detection. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least a small ML model fraud detection engine 102, an inference analysis engine 104, and a large ML model fraud detection engine 106. Each of these engines in the system 100 runs on one or more computing units/appliances/devices/hosts (not shown) each having one or more processors and software instructions stored in a storage unit such as a non-volatile memory of the computing unit for practicing one or more processes. When the software instructions are executed, at least a subset of the software instructions is loaded into memory (also referred to as primary memory) by one of the computing units, which becomes a special purposed one for practicing the processes. The processes may also be at least partially embodied in the computing units into which computer program code is loaded and/or executed, such that, the host becomes a special purpose computing unit for practicing the processes.

In the example of FIG. 1, each computing unit can be a computing device, a communication device, a storage device, or any computing device capable of running a software component. For non-limiting examples, a computing device can be but is not limited to a server machine, a laptop PC, a desktop PC, a tablet, a Google Android device, an iPhone, an iPad, and a voice-controlled speaker or controller. Each of the engines in the system 100 is associated with one or more communication networks (not shown), which can be but is not limited to, Internet, intranet, wide area network (WAN), local area network (LAN), wireless network, Bluetooth, Wi-Fi, and mobile communication network for communications among the engines. The physical connections of the communication networks and the communication protocols are well known to those skilled in the art.

In the example of FIG. 1, the small ML model fraud detection engine 102 is configured to receive or intercept an email intended for a recipient/user within an organization/entity/corporation before the email reaches the user's email account and become accessible by the user. In some embodiments, the small ML model fraud detection engine 102 is configured to intercept the email at a firewall, a gateway, a proxy, or a relay mechanism of the organization along a path following a governing communication protocol. For non-limiting examples, the communication protocol can be but is not limited to Simple Mail Transfer Protocol (SMTP) or Hyper Text Transfer Protocol (HTTP). The proxy or a relay mechanism can be but is not limited to a message transfer agent or a Web proxy depending on the communication protocol being used.

After intercepting an email, the small ML model fraud detection engine 102 is configured to utilize one or more small ML models to make an initial classification or sorting of the email with fast inference time. In some embodiments, the small ML model fraud detection engine 102 is configured to calculate/assign a confidence score for the one or more small ML models utilized to make initial classification of the email, wherein the confidence score reflects the level of confidence that the email is fraud or not based on the one or more small ML models utilized. In some embodiments, each of the one or more small ML models is small in size in terms of number of parameters, e.g., having thousands to hundreds of thousands of parameters, and thus requiring less processing power and having fast inference time for online/real time identification of fraud emails. In some embodiments, the one or more small ML models of the small ML model fraud detection engine 102 can be deployed on one or more general purpose CPU-accelerated units/endpoints. In some embodiments, each of the one or more small ML models is trained using knowledge distillation technique, which is a process of transferring knowledge from a large ML model having, e.g., millions of parameters, to the small one so that the small ML model can mimic the large ML model in terms of inference accuracy. In some embodiments, one of the one or more small ML models is an ML algorithm that uses ensemble learning to solve classification and regression of the email. In some embodiments, one of the one or more small ML models is an ML algorithm that uses gradient boosting to create one or more decision trees for classification of the email. After classifying the email based on the one or more small ML models, the small ML model fraud detection engine 102 is configured to provide/send the initial classification of the email with the confidence score for the one or more small ML models to the inference analysis engine 104 in real time.

In the example of FIG. 1, upon receiving the initial classification of the email with the confidence score from the small ML model fraud detection engine 102, the inference analysis engine 104 is configured to analyze the initial classification of the email with the confidence score in real time to determine if further analysis is needed before reporting to a customer, who can be but is not limited to a system admin of the organization and/or the intended recipient of the email. If the confidence score of the one or more small ML models used by the small ML model fraud detection engine 102 to determine the initial classification of the email is higher than an adjustable threshold, the inference analysis engine 104 is configured to pass the initial classification of the email directly to the customer. As such, the system 100 maintains a fast inference time by mainly relying on the initial classification made by the small ML model fraud detection engine 102 with a threshold adjustable by the customer when classifying the email.

If, however, the confidence score is below the adjustable threshold, indicating that the initial classification by the one or more small ML models may not be accurate, the inference analysis engine 104 is configured to send the email to the large ML model fraud detection engine 106 for further/final classification before passing the final classification of the email to the customer. Once the large ML model fraud detection engine 106 makes a final classification of the email, e.g., whether the email is fraudulent or not, the inference analysis engine 104 is configured to obtain/retrieve the final classification from the large ML model fraud detection engine 106 and report the final classification of the email to the customer accordingly. In some embodiments, the inference analysis engine 104 is configured to continuously re-train the one or more small ML models utilized by the small ML model fraud detection engine 102 to make the initial classification with the new/final classification and related information as training data for the small ML models. In some embodiments, the inference analysis engine 104 is configured to include the email and/or one or more labels generated by the large ML model fraud detection engine 106 for the email to the training data for the one or more small ML models.

In the example of FIG. 1, the large ML model fraud detection engine 106 is configured to accept the email from the inference analysis engine 104 and to utilize one more large ML models to carry out in-depth analysis for an accurate final classification of the email (e.g., fraudulent or not) with greater accuracy. Here, the one or more large ML models perform reasonably high accuracy inference and can be used in case the one or more small models has low confidence score for the initial classification as discussed above. In some embodiments, the one or more large ML models are enabled by one or more GPUs with high discriminatory powers to process large number of parameters, e.g., from millions to tens of millions of parameters. Here, each of the one or more large ML models can be but is not limited to an LLM and a multimodal model. Here, the LLM can be a type of artificial intelligence (AI) algorithm that uses deep learning techniques (e.g., deep neural network models) and large datasets to perform natural language processing (NLP) tasks by recognizing natural language content of the email. A multimodal model is an ML model typically including multiple neural networks, each specialized in analyzing a particular modality. The multimodal model can process information from multiple sources, such as text, images, audio, and video, etc. to build a more complete understanding of content of the email and unlock new insights for classification of the email. Once the final classification of the email has been made, the large ML model fraud detection engine 106 is configured to provide the final classification to the inference analysis engine 104 for reporting to the customer.

In some embodiments, the large ML model fraud detection engine 106 is configured to interpret and classify an intent of an image in the email through one or more LLMs and/or multimodal models for fraud email detection. Here, a fraud email can be but is not limited to a phishing email, a spam email, and any other type of fraudulent email. Specifically, the large ML model fraud detection engine 106 is configured to use the one or more LLMs and/or multimodal models as a feature extraction mechanism for image detection in the fraud email. In some embodiments, the large ML model fraud detection engine 106 requires the LLMs and/or multimodal models to have described the image prior to classification in order to achieve high efficacy for fraud email detection. the large ML model fraud detection engine 106 then utilizes such description of the image as one or more features to train the LLMs and/or multimodal models to make a prediction/classification of the email for fraud detection, wherein such prediction is close to what a human observes.

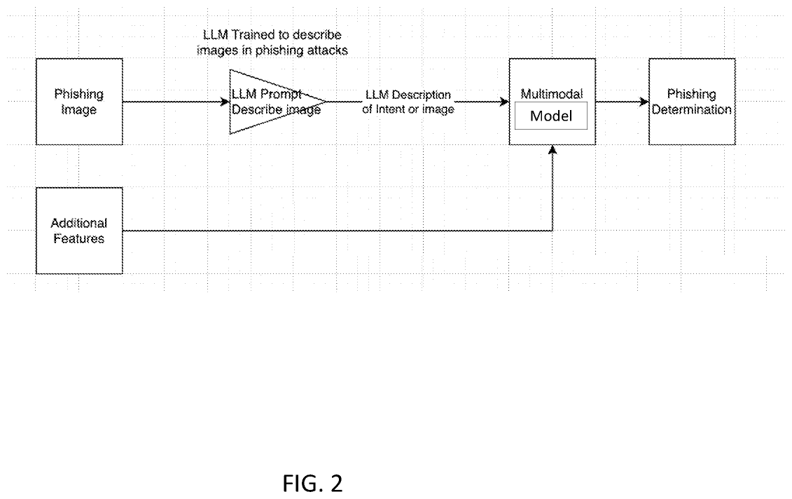

FIG. 2 depicts an example of a process of classifying intent of an image in a phishing email through one or more LLMs and/or multimodal models. As shown by the example of FIG. 2, a phishing email is created by a malicious actor who encodes the content of the phishing email into an image, wherein the phishing image may contain logos or other impersonation mechanisms. The large ML model fraud detection engine 106 utilizes/prompts an LLM trained to describe images used in phishing and/or spam attacks to provide a description of the image. For a non-limiting example, such description of the image can be in the form of “an invoice with the Microsoft logo in the corner.” The description of the image is then fed to a multimodal model with the image and any additional features of the email (e.g., statistics) that are used for impersonation, phishing, or spam. The large ML model fraud detection engine utilizes the multimodal model to make a phishing classification/determination of the image by combining the image with the description and/or the additional features, which the description and/or features allow for a much higher accuracy in determining the intent of the image for the multimodal model.

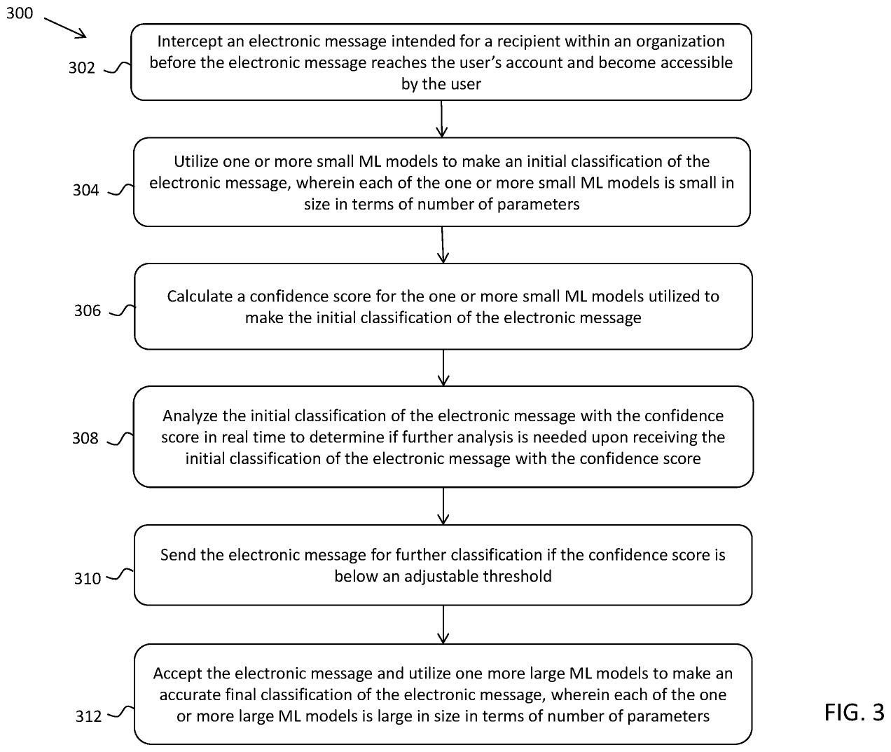

FIG. 3 depicts a flowchart 300 of an example of a process to support utilizing multiple machine learning models for fraudulent electronic message detection. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302, where an electronic message intended for a recipient within an organization is intercepted before the electronic message reaches the user's account and becomes accessible by the user. The flowchart 300 continues to block 304, where one or more small ML models are utilized to make an initial classification of the electronic message, wherein each of the one or more small ML models is small in size in terms of the number of parameters. The flowchart 300 continues to block 306, where a confidence score for the one or more small ML models utilized to make the initial classification of the electronic message is calculated. The flowchart 300 continues to block 308, where the initial classification of the electronic message with the confidence score is analyzed in real time to determine if further analysis is needed upon receiving the initial classification of the electronic message with the confidence score. The flowchart 300 continues to block 310, where the electronic message is sent for further classification if the confidence score is below an adjustable threshold. The flowchart 300 ends at block 312, where the electronic message is accepted and one more large ML models are utilized to make an accurate final classification of the electronic message, wherein each of the one or more large ML models is large in size in terms of the number of parameters.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine-readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A system, comprising:
a small machine learning (ML) model fraud detection engine configured to
intercept an electronic message intended for a recipient within an organization before the electronic message reaches the user's account and become accessible by the user;
utilize one or more small ML models to make an initial classification of the electronic message, wherein each of the one or more small ML models is small in size in terms of number of parameters;
calculate a confidence score for the one or more small ML models utilized to make the initial classification of the electronic message;
an inference analysis engine configured to
analyze the initial classification of the electronic message with the confidence score in real time to determine if further analysis is needed upon receiving the initial classification of the electronic message with the confidence score;
send the electronic message for further classification if the confidence score is below an adjustable threshold;
a large ML model fraud detection engine configured to accept the electronic message and utilize one more large ML models to make an accurate final classification of the electronic message, wherein each of the one or more large ML models is large in size in terms of the number of parameters.

2. The system of claim 1, wherein:
the electronic message is one or more of an email, a text message, an instant message, an online chat on a social media platform, a voice message or mail that is automatically converted to be in an electronic text format, or other form of text-based electronic communication.

3. The system of claim 1, wherein:
the one or more small ML models are deployed on one or more general purpose CPU-accelerated units.

4. The system of claim 1, wherein:
each of the one or more small ML models is trained using knowledge distillation technique, which is a process of transferring knowledge from a large ML model to a small ML model so that the small ML model mimic the large ML model in terms of inference accuracy.

5. The system of claim 1, wherein:
one of the one or more small ML models is a ML algorithm that uses ensemble learning to solve classification and regression of the electronic message.

6. The system of claim 1, wherein:
one of the one or more small ML models is a ML algorithm that uses gradient boosting to create decision one or more trees for classification of the electronic message.

7. The system of claim 1, wherein:
the inference analysis engine is configured to report the initial classification of the electronic message directly to a customer if the confidence score is higher than the adjustable threshold.

8. The system of claim 1, wherein:
the inference analysis engine is configured to obtain and report the final classification of the electronic message to the customer.

9. The system of claim 1, wherein:
the inference analysis engine is configured to continuously re-train the one or more small ML models utilized to make the initial classification with the final classification and related information as training data.

10. The system of claim 9, wherein:
the inference analysis engine is configured to include the electronic message and/or one or more labels generated for the electronic message to the training data for the one or more small ML models.

11. The system of claim 1, wherein:
each of the one or more large ML models is a large language model (LLM) or a multimodal model.

12. The system of claim 11, wherein:
the large ML model fraud detection engine is configured to interpret and classify an intent of an image in the electronic message through the LLM and the multimodal model for fraud email detection.

13. The system of claim 12, wherein:
the large ML model fraud detection engine is configured to utilize the LLM trained to describe images used in phishing and/or spam attacks to provide a description of the image.

14. The system of claim 13, wherein:
the large ML model fraud detection engine is configured to utilize the multimodal model to make a phishing classification of the image by combining the image with the description and/or one or more additional features.

15. A computer-implemented method, comprising:
intercepting an electronic message intended for a recipient within an organization before the electronic message reaches the user's account and become accessible by the user;
utilizing one or more small ML models to make an initial classification of the electronic message, wherein each of the one or more small ML models is small in size in terms of number of parameters;
calculating a confidence score for the one or more small ML models utilized to make the initial classification of the electronic message;
analyzing the initial classification of the electronic message with the confidence score in real time to determine if further analysis is needed upon receiving the initial classification of the electronic message with the confidence score;
sending the electronic message for further classification if the confidence score is below an adjustable threshold;
accepting the electronic message and utilizing one more large ML models to make an accurate final classification of the electronic message, wherein each of the one or more large ML models is large in size in terms of the number of parameters.

16. The method of claim 15, further comprising:
training each of the one or more small ML models using knowledge distillation technique, which is a process of transferring knowledge from a large ML model to a small ML model so that the small ML model mimic the large ML model in terms of inference accuracy.

17. The method of claim 15, further comprising:
using ensemble learning to solve classification and regression of the electronic message via one of the one or more small ML models.

18. The method of claim 15, further comprising:
using gradient boosting to create decision one or more trees for classification of the electronic message via one of the one or more small ML models.

19. The method of claim 15, further comprising:
reporting the initial classification of the electronic message directly to a customer if the confidence score is higher than the adjustable threshold.

20. The method of claim 15, further comprising:
obtaining and reporting the final classification of the electronic message to the customer.

21. The method of claim 15, further comprising:
continuously re-training the one or more small ML models utilized to make the initial classification with the final classification and related information as training data.

22. The method of claim 21, further comprising:
including the electronic message and/or one or more labels generated for the electronic message to the training data for the one or more small ML models.

23. The method of claim 15, further comprising:
interpreting and classifying an intent of an image in the electronic message through a large language model (LLM) and a multimodal model for fraud email detection.

24. The method of claim 23, further comprising:
utilizing the LLM trained to describe images used in phishing and/or spam attacks to provide a description of the image.

25. The method of claim 24, further comprising:
utilizing the multimodal model to make a phishing classification of the image by combining the image with the description and/or one or more additional features.

26. A non-transitory storage medium having software instructions stored thereon that when executed cause a system to:
intercept an electronic message intended for a recipient within an organization before the electronic message reaches the user's account and become accessible by the user;
utilize one or more small ML models to make an initial classification of the electronic message, wherein each of the one or more small ML models is small in size in terms of number of parameters;
calculate a confidence score for the one or more small ML models utilized to make the initial classification of the electronic message;
analyze the initial classification of the electronic message with the confidence score in real time to determine if further analysis is needed upon receiving the initial classification of the electronic message with the confidence score;
send the electronic message for further classification if the confidence score is below an adjustable threshold;
accept the electronic message and utilize one more large ML models to make an accurate final classification of the electronic message, wherein each of the one or more large ML models is large in size in terms of the number of parameters.
